(19) United States
(12) Patent Application Publication
(10) Pub. No.: US 2026/0030981 A1
(43) Pub. Date: Jan. 29, 2026

(54) DISPLAY CONTROL DEVICE

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/049,160

(22) Filed: Feb. 10, 2025

(30) Foreign Application Priority Data
Jul. 24, 2024 (JP) 2024-118954

(51) Int. Cl. G08G 1/0967; G08G 1/0968

(52) U.S. Cl. CPC G08G 1/0967; G08G 1/096855

(57) ABSTRACT

The display control device includes a display control unit configured to display a host vehicle image imitating the host vehicle on a display unit provided around a driver's seat of the host vehicle, and to display an instruction image indicating a recommended action of the host vehicle determined based on information regarding an emergency vehicle approaching the host vehicle and a road condition around the host vehicle.

### CROSS-REFERENCE TO RELATED APPLICATION

This application claims priority to Japanese Patent Application No. 2024-118954 filed on Jul. 24, 2024. The disclosure of the above-identified application, including the specification, drawings, and claims, is incorporated by reference herein in its entirety.

### BACKGROUND

### 1. Technical Field

The present disclosure relates to a display control device.

### 2. Description of Related Art

Japanese Patent No. 7048398 (JP 7048398 B) discloses a vehicle control device capable of performing autonomous driving that gives a sense of security to an occupant.

### SUMMARY

In the technology according to JP 7048398 B, an image indicating a host vehicle, an image indicating the surrounding situation of the host vehicle, and the like are displayed on a display unit (see FIG. 8 of JP 7048398 B). In the related art, however, there is no indication as to what kind of traveling should be performed when an emergency vehicle is approaching.

An object of the present disclosure is to provide a display control device that allows a driver of a host vehicle to grasp an action to be taken by the driver of the host vehicle on an emergency vehicle.

A display control device according to a first aspect of the present disclosure includes a display control unit configured to cause a display unit provided around a driver's seat of a host vehicle to display a host vehicle image simulating the host vehicle, and configured to cause the display unit to display an instruction image showing a recommended action of the host vehicle that is determined based on information on an emergency vehicle approaching the host vehicle and a road condition around the host vehicle.

The display control device according to the first aspect of the present disclosure allows the driver of the host vehicle to grasp the action to be taken by the driver of the host vehicle on the emergency vehicle.

In the first aspect of the present disclosure, the display control unit is configured to display the instruction image showing the recommended action determined based on at least one piece of information out of a position, a traveling route, and an alert of the detected emergency vehicle. The display control device according to the first aspect of the present disclosure allows the driver of the host vehicle to grasp the action to be taken by the driver of the host vehicle by presenting the recommended action determined according to the condition of the emergency vehicle.

In the display control device according to the first aspect of the present disclosure, the road condition is at least one piece of information out of position information of a vehicle around the host vehicle and lane information on a lane where the host vehicle is travelable. The display control device according to the first aspect of the present disclosure determines a safe recommended action using the information on the surrounding vehicle or the lane, thereby allowing the driver of the host vehicle to grasp the action to be taken by the driver of the host vehicle.

In the display control device according to the first aspect of the present disclosure, the display control unit is configured to display the instruction image showing at least one of a recommended route of the host vehicle and a recommended stop position of the host vehicle. The display control device according to the first aspect of the present disclosure allows the driver of the host vehicle to grasp the action to be taken by the driver of the host vehicle by drawing the recommended action.

According to the technology of the present disclosure, it is possible to present the recommended action of the host vehicle on the emergency vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of a vehicle;

FIG. 2 is a first display example displayed on a monitor;

FIG. 3 is a second display example displayed on a monitor;

FIG. 4 is a third exemplary display displayed on a monitor; and

FIG. 5 is a flowchart illustrating a flow of the specifying process.

### DETAILED DESCRIPTION OF EMBODIMENTS

Hereinafter, the vehicle 10 according to the present embodiment will be described.

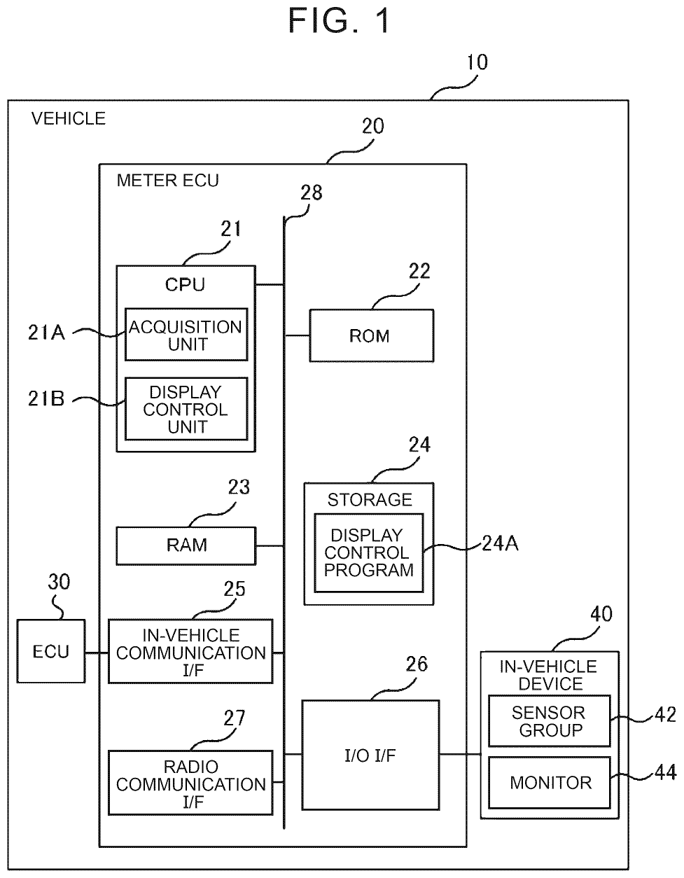

FIG. 1 is a block diagram illustrating a hardware configuration of a vehicle 10. As illustrated in FIG. 1, the vehicles 10 include a meter ECU (Electronic Control Unit) 20. The vehicle 10 is an example of a “vehicle” of the present disclosure, and the meter ECU 20 is an example of a “display control device” of the present disclosure.

The meter ECU 20 includes CPU (Central Processing Unit) 21, ROM (Read Only Memory) 22, RAM (Random Access Memory) 23, storage 24, in-vehicle communication I/F (Inter Face) 25, input/output I/F 26, and radio communication I/F 27. CPU 21, ROM 22, RAM 23, the storage 24, the in-vehicle communication I/F 25, the input/output I/F 26, and the radio communication I/F 27 are communicably connected to each other via an inner bus 28.

CPU 21 is a central processing unit that executes various programs and controls each unit. That is, CPU 21 reads the program from ROM 22 or the storage 24, and executes the program using RAM 23 as a working area. CPU 21 performs control of the above-described configurations and various arithmetic processes in accordance with programs recorded in ROM 22 or the storage 24.

ROM 22 stores various programs and various data. RAM 23 temporarily stores a program/data as a working area.

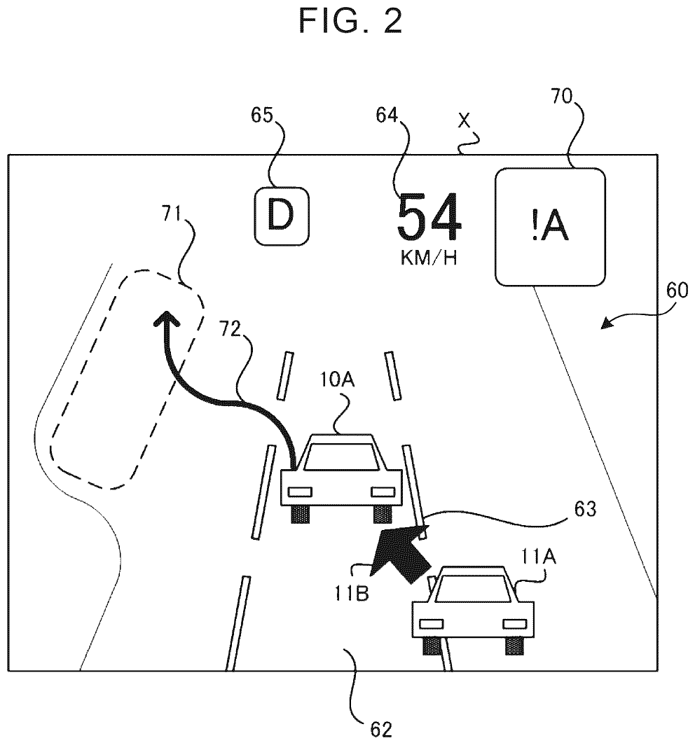

The storage 24 is constituted by a storage device such as an eMMC (embedded Multi-Media Card) or a UFS (Universal Flash Storage), and stores various programs and various data. The storage 24 stores a display-control-program 24A. The display control program 24A is a program for causing CPU 21 to execute a specifying process (see FIG. 2) to be described later.

The in-vehicle communication I/F 25 is an interface for connecting to another ECU 30. The interface uses a CAN protocol-based communication standard. The in-vehicle communication I/F 25 is connected to an external bus 29. Although not shown, a plurality of ECU are provided for each function of the vehicles 10 in addition to ECU 30.

The input/output I/F 26 is an interface for communicating with the in-vehicle device 40 mounted on the vehicle 10.

The in-vehicle device 40 is a variety of devices mounted on the vehicle 10. The vehicle 10 includes a sensor group 42 and a monitor 44 as an example of the in-vehicle device 40.

The sensor group 42 includes, for example, a 3D-LiDAR, a millimeter-wave sensor, an infrared sensor, a winker sensor, an accelerator position sensor, a vehicle speed sensor, a steering angle sensor, an angular velocity sensor, a GPS (Global Positioning System) sensor, an illuminance sensor, and a gyrosensor. The sensor group 42 includes, for example, a sensor for detecting a state of the vehicle 10, such as an acceleration sensor, and a state around the vehicle 10, and a plurality of cameras for imaging the periphery of the vehicle 10. The sensor group 42 outputs a detection result of each sensor and an image captured by each camera to the meter ECU 20, ECU 30, and the like.

The monitor 44 is a meter display provided on a meter panel disposed in front of the driver's seat of the vehicle 10 and for displaying an operation proposal related to the function of the vehicle 10, an image related to the explanation of the function, and the like. The monitor 44 is an example of a “display unit” of the present disclosure. Note that the monitor 44 is not limited to the meter panel in front of the driver's seat, and may be provided around the driver's seat.

The radio communication I/F 27 is a wireless communication module for communicating with an external device. As the radio communication module, for example, communication standards such as 5G, LTE, Wi-Fi (registered trademark) and Bluetooth (registered trademark) are used.

Further, CPU 21 of the meter ECU 20 has, as a functional configuration, an acquiring unit 21A and a display control unit 21B. The respective functional configurations are realized by CPU 21 reading and executing the display-control-program 24A stored in the storage 24.

The acquiring unit 21A acquires various types of data. For example, the acquiring unit 21A acquires, as various types of information, peripheral information around the vehicle 10 that can be detected by the vehicle 10. The peripheral information includes a detection result by each sensor constituting the sensor group 42, a captured image by each camera, and the like.

The display control unit 21B performs display control related to the display of the monitor 44. For example, as the display control, the display control unit 21B causes the display area X of the monitor 44 to display the host vehicle image 10A (see FIG. 2 and the like) indicating the vehicle 10 when viewed from the virtual viewpoint, based on the surrounding information acquired by the acquiring unit 21A. The virtual viewpoint is set on a three-dimensional virtual space whose origin is the position of the host vehicle image 10A, and is defined by viewpoint coordinates and viewpoint angles (orientations) on the virtual space. For example, the virtual viewpoint is a viewpoint viewed at a specific viewpoint angle from a specific viewpoint coordinate on the upper side of the host vehicle image 10A in the virtual space.

ECU 30 also determines the recommended action of the vehicle 10 based on the information about the emergency vehicle and the road conditions around the host vehicle. The road condition around the host vehicle is the position information of the vehicle around the host vehicle and the lane information related to the lane on which the host vehicle can travel.

The display control unit 21B causes the monitor 44 to display instruction images indicating the recommended actions determined by ECU 30 (to be described later).

FIG. 2 is a diagram illustrating a first display example displayed on a monitor. As illustrated in FIG. 2, a host vehicle image 10A indicating the vehicle 10 is displayed. In addition, in the area X, a lane image 62 indicating the traveling lane of the vehicle 10 and a white line image 63 indicating the white line defining the traveling lane are displayed as peripheral images indicating the surrounding situation. Further, an image 64 indicating vehicle speed information of the vehicle 10 and an image 65 indicating a shift position of the vehicle 12 are displayed above the lane image 62.

Here, in FIG. 2, the sensor group 42 detects an emergency vehicle moving from the right lane behind the vehicle 10 to the lane on which the vehicle 10 travels and approaching. When the emergency vehicle is detected, the display control unit 21B causes the emergency vehicle imaging 11A and the alerting information 70 to be displayed as information about the emergency vehicle. In addition, a moving-direction 11B of the emergency vehicle is displayed as the information about the emergency vehicle. The sensor group 42 detects a retreat area 71 indicating the position of the approaching emergency vehicle and a retreatable road shoulder in a direction different from the direction of the traveling route of the emergency vehicle. The display control unit 21B causes the instruction images 72 indicating the recommended actions to be saved in the retreat area 71 to be displayed. In the example of FIG. 2, the recommended route indicating the evacuation route up to the retreat area 71 is displayed as the instruction image 72. Accordingly, it is possible to navigate a traveling route for evacuation to the emergency vehicle. It should be noted that a recommended action is presented which is not limited to the approach from the rear, but can be evacuated by avoiding a collision also in the case of approaching from the front or the side.

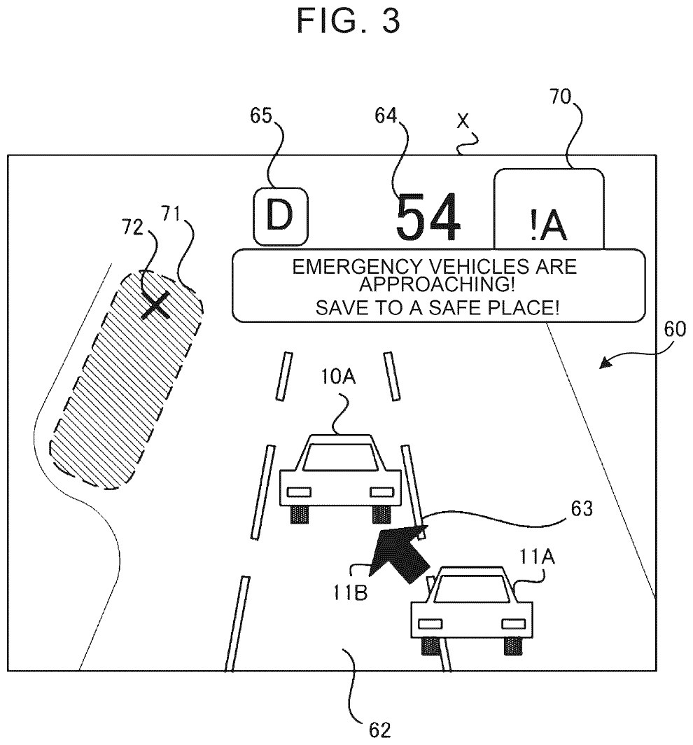

Note that the instruction image 72 is not limited to the recommended route indicating the evacuation route up to the retreat area 71 as long as the information indicates the recommended action. FIG. 3 is a diagram illustrating a second display example displayed on the monitor. For example, along with alert information indicating an alarm for an emergency vehicle, an explanation is “The emergency vehicle is approaching! “Please evacuate to a safe place!” The display may be performed. Alternatively, the retreat area 71 may be blinked to notify that there is an evacuation area. Further, an instruction image 72 indicating a recommended stop position of the retreat area 71 is displayed. This makes it possible to navigate the travel to the recommended stop position.

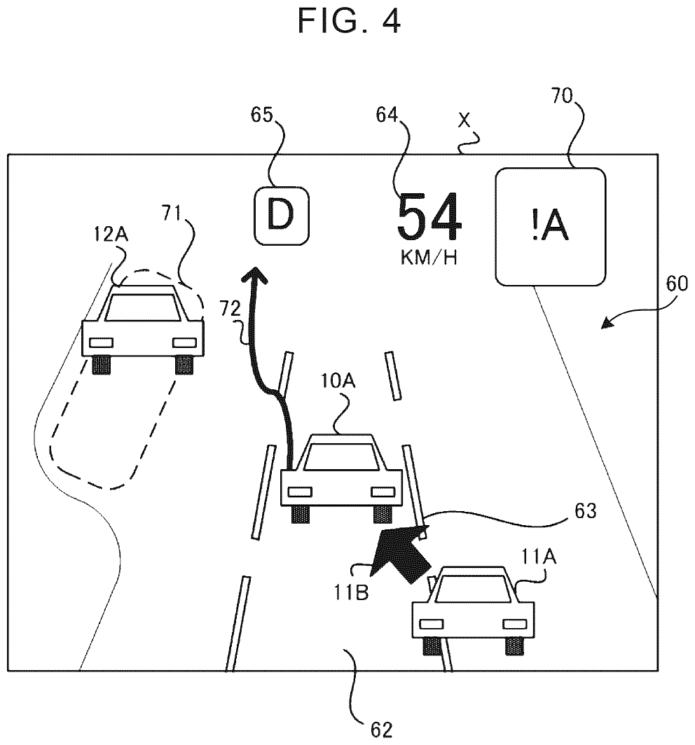

In addition, although the case where the recommended route or the recommended stop position of the retreat area 71 is indicated has been described as an example, the present disclosure is not limited to this. FIG. 4 is a diagram illustrating a third display example displayed on the monitor. For example, it is assumed that, as a result of detecting the position information of the vehicle around the vehicle 10, the other vehicle is stopped in the retreat area 71 and cannot retreat. In this situation, the other-vehicle images 12A are displayed in the retreat area 71. ECU 30 detects the left lane adjoining the traveling lane of the vehicle 10 as a lane on which the host vehicle can travel without any other vehicle. Therefore, the display control unit 21B displays the instruction images 72 indicating the recommended routes to the left lane. Accordingly, it is possible to navigate a traveling route for evacuation to the emergency vehicle.

### Control Flow

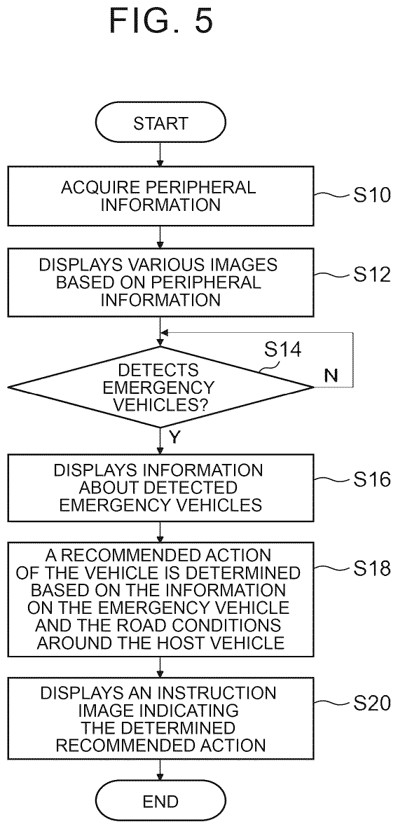

FIG. 5 is a flow chart illustrating a flow of a specifying process executed by the meter ECU 20. CPU 21 reads the display-control-program 24A from the storage 24, develops it in RAM 23, and executes it, thereby performing the specifying process. As an example, the identification processing is performed repeatedly and automatically every time a certain period of time elapses.

In S10, CPU 21 acquires peripheral information that can be detected by the vehicles 10. Then, CPU 51 proceeds to S12.

In S12, CPU 21 displays various images on the monitor 44 based on the peripheral data acquired by S10. The various images are a host vehicle image 10A, a lane image 62 indicating a road on which the vehicle 10 travels, and the like.

In S14, CPU 21 determines whether an emergency vehicle has been detected. If it is determined that it has been detected, the process proceeds to S16. If it is determined that there is no detection, this step is repeated.

In S16, CPU 21 causes the detected emergency vehicles to be displayed.

In S18, ECU 30 determines the recommended action of the vehicle 10 based on the information about the emergency vehicle and the roadway conditions around the host vehicle.

In S20, CPU 21 causes the monitor 44 to display an instruction image indicating the determined recommended action.

As described above, in the meter ECU 20 (display control device), CPU 21 displays information about the detected emergency vehicles. Further, CPU 21 causes the monitor 44 to display an instruction image indicating the determined recommended action. Accordingly, the meter ECU 20 can cause the emergency vehicle to recognize an action to be taken by the driver of the host vehicle.

Also. The recommended action may be changed according to the type of the emergency vehicle and the position of the host vehicle. For example, if the emergency vehicle is a police motorcycle, the recommended route is determined so as to avoid changing the lane, and if the host vehicle is within the intersection, the recommended route is determined so as to accelerate and escape from the intersection. As described above, the recommended action may be appropriately taken in accordance with the road conditions.

In the above embodiment, the monitor 44, which is a meter display, is an example of the “display unit” of the present disclosure, but the example of the “display unit” is not limited to the meter display. For example, an exemplary “display unit” may be other displays, such as a center display and a head-up display (HUD). An example of the “display unit” may be a combination of a plurality of displays such as a meter display and a center display.

In the above-described embodiment, the meter ECU 20 executes the specifying process illustrated in FIG. 5. However, the present disclosure is not limited thereto, and the specifying process may be executed by the meter ECU 20 and other ECU in cooperation with each other.

It should be noted that the identifying process executed by CPU 21 reading the software (program) in the above-described embodiment may be executed by various processors other than CPU. The processor in this case includes an exclusive electric circuit that is a processor including a circuit configuration exclusively designed for executing specific processing, such as programmable logic device (PLD) having a circuit configuration that can be changed after the manufacture including a field-programmable gate array (FPGA), and an application specific integrated circuit (ASIC). Further, the specifying process may be executed by one of these various processors, or may be executed by a combination of two or more processors (for example, a plurality of FPGA, a combination of CPU and FPGA, and the like) of the same type or different types. Further, a hardware structure of the various processors is, more specifically, an electric circuit in which circuit elements such as semiconductor elements are combined.

In the above embodiment, the display control program 24A is stored (installed) in the storage 24 in advance, but the present disclosure is not limited thereto. The display-control-program 24A may be provided in a form recorded in a recording medium such as CD-ROM (Compact Disk Read Only Memory), DVD-ROM (Digital Versatile Disk Read Only Memory), and USB (Universal Serial Bus). In addition, the display-control-program 24A may be downloaded from an external device via a network. Note that the technology of the present disclosure can also be applied to programs and program products.

What is claimed is:

1. A display control device comprising a display control unit configured to cause a display unit provided around a driver's seat of a host vehicle to display a host vehicle image simulating the host vehicle, and configured to cause the display unit to display an instruction image showing a recommended action of the host vehicle that is determined based on information on an emergency vehicle approaching the host vehicle and a road condition around the host vehicle.

2. The display control device according to claim 1, wherein the display control unit is configured to display the instruction image showing the recommended action determined based on at least one piece of information out of a position, a traveling route, and an alert of the detected emergency vehicle.

3. The display control device according to claim 1, wherein the road condition is at least one piece of information out of position information of a vehicle around the host vehicle and lane information on a lane where the host vehicle is travelable.

4. The display control device according to claim 1, wherein the display control unit is configured to display the instruction image showing at least one of a recommended route of the host vehicle and a recommended stop position of the host vehicle.
